(19) United States
(12) Patent Application Publication
(10) Pub. No.: US 2016/0078450 A1
(43) Pub. Date: Mar. 17, 2016

(54) Commitment Tracking System

(71) Applicant: Bank of America Corporation, Charlotte, NC (US)

(72) Inventors: Brian J. Warshaw, Saint Johns, FL (US); James W. Graczyk, Jacksonville, FL (US); Prem Narayanan, Monmouth Junction, NJ (US); Chris Cioffi, St. Augustine, FL (US); Carlos Ordonez, St. Augustine, FL (US); Jeannie M. Darwin, Saint Johns, FL (US); Olga Brender, Huntingdon Valley, PA (US); Ramesh Kuppusamy, Dayton, NJ (US)

(21) Appl. No.: 14/487,186

(22) Filed: Sep. 16, 2014

(51) Int. Cl. G06Q 30/00; G06Q 40/00

(52) U.S. Cl. CPC G06Q 30/018; G06Q 40/00

(57) ABSTRACT

Aspects described herein provide various approaches for managing financial commitments for customers of a financial institution. Financial data regarding a financial commitment for a customer of the financial institution may be received from one or more computing devices. An action item for the financial commitment may be determined based on the received financial data regarding the financial commitment. A priority level and one or more due dates may be assigned to the action item based on financial regulations. An interface comprising the action item, the priority level, and the one or more due dates for the financial commitment may be generated and sent to one or more computing devices.

### BACKGROUND

For most organizations, managing accounts and keeping track of regulatory standards may be of paramount importance. For example, financial institutions may set specific policies for employees at branch offices to follow in order to satisfy regulatory standards. For example, regulatory organizations such as Financial Industry Regulatory Authority (FINRA) and the Securities and Exchange Commission (SEC) may establish certain standards and regulations for financial institutions.

Financial institutions may often perform reviews of account details for financial commitments in order to ensure that regulations are being met. In some financial institutions, however, there may be hundreds or thousands of accounts, as well as a large volume of calls that are received each day from customers, wherein each call is regarding a different account. In conventional systems, reviewing this information may necessitate significant amounts of time to find and retrieve pertinent details from different sources and to determine the appropriate course of action for each account. Furthermore, conventional tools for analysis or review may only provide a limited view of information on multiple screens. With the large volume of calls that are received each day, it may be increasingly difficult to keep up with reviews and comply with established policies. Therefore, a need exists for improved approaches to financial commitment tracking in order to meet regulatory standards.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

Some aspects as disclosed herein are directed to, for example, a system and method of receiving, from one or more computing devices, financial data regarding a financial commitment for a customer of a financial institution. The method may include determining an action item for the financial commitment, based on the received financial data regarding the financial commitment; assigning a priority level and one or more due dates for the action item for the financial commitment, wherein the assignment is based on financial regulations; generating an interface comprising the action item, the priority level, and the one or more due dates for the action item for the financial commitment; and sending, to the one or more computing devices, the interface comprising the action item, the priority level, and the one or more due dates for the action item for the financial commitment.

Responsive to assigning the priority level and the one or more due dates for the action item for the financial commitment, the method may include determining whether an extension is available according to the financial regulations or internal policies. In response to determining that the extension is available, an instruction may be sent to the one or more computing devices to request the extension from a regulatory organization.

Responsive to assigning the priority level and the one or more due dates for the action item for the financial commitment, the method may include determining whether collateral assets of the customer for the financial commitment are available. In response to determining that the collateral assets are available, an instruction may be sent to the one or more computing devices to liquidate the collateral assets of the customer for the financial commitment.

In some aspects, the financial data may be associated with at least one of a maintenance call, a minimum option equity call, a collateral call, a naked option stress analysis call, a purchase, a sale, or a regulation T call, and the action item for the financial commitment may comprise a compliance action item.

In some aspects, the financial data may be associated with at least one of a resource deficit, an account receivable, or a non-trade related cash shortage, and the action item for the financial commitment may comprise a collection action item.

In some aspects, the financial data may be associated with at least one of a day trading violation, a predetermined period of time restriction, a day trade minimum equity call, a cash account violation, or a regulation T call violation, and the action item for the financial commitment may comprise a violation action item.

In some aspects, the one or more due dates may comprise at least one of a customer due date, a branch due date, a home office due date, or a compliance due date. In some aspects, the priority level may comprise at least one of a first priority indicating that the action item is overdue, a second priority level indicating that the action item is currently due, or a third priority level indicating that the action item is due at a later date.

Furthermore, the determination of the action item for the financial commitment may be based on the financial regulations established by the Federal Reserve, Financial Industry Regulatory Authority (FINRA) and the Securities and Exchange Commission (SEC) or internal policies.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments.

FIG. 2 depicts an illustrative block diagram of workstations and servers that may be used to implement the processes and functions of certain aspects of the present disclosure in accordance with one or more example embodiments.

FIG. 3 depicts an illustrative computing environment for financial commitment management in accordance with one or more example embodiments.

FIG. 4 depicts an illustrative sequence diagram for financial commitment tracking in accordance with one or more example embodiments.

FIG. 5 depicts an illustrative table of example action items for financial commitments in accordance with one or more example embodiments.

FIG. 6 depicts an illustrative flow diagram for determining action items for financial commitments in accordance with one or more example embodiments.

FIG. 7 depicts an illustrative flow diagram for ensuring compliance for financial commitments in accordance with one or more example embodiments.

FIGS. 8A, 8B, 8C, and 8D depict illustrative diagrams of a user interface of the commitment tracking system in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

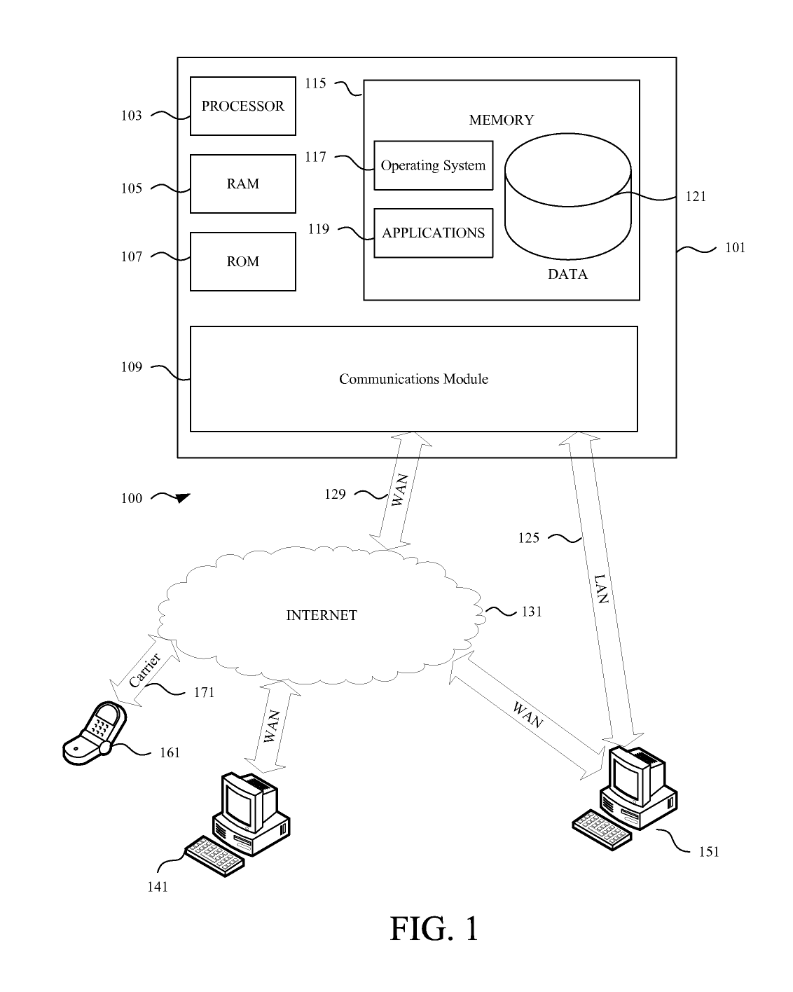

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

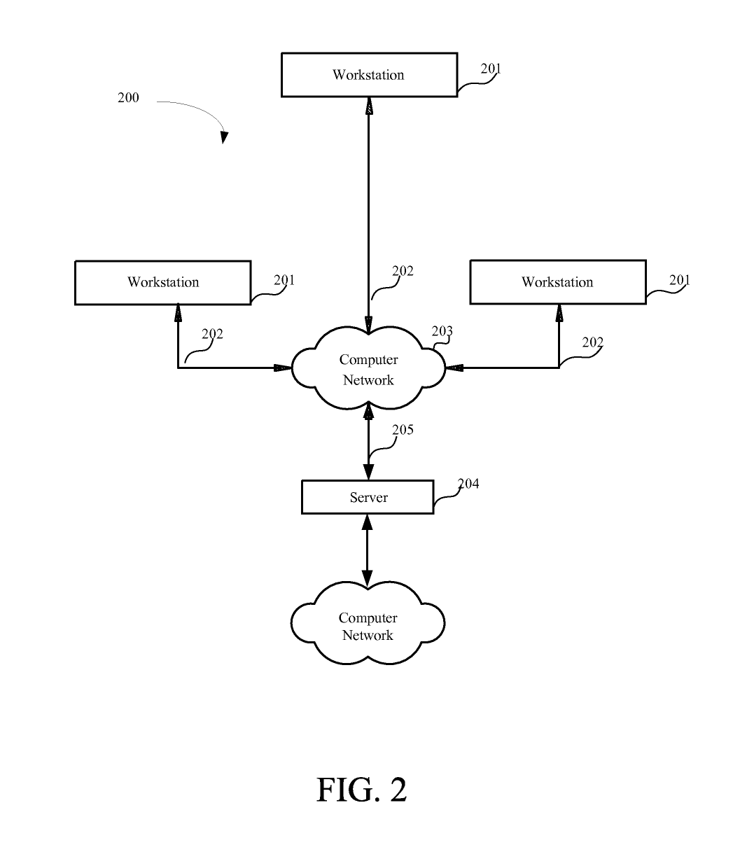

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

Having described an example of a computing device that can be used in implementing various aspects of the disclosure and an operating environment in which various aspects of the disclosure can be implemented, several embodiments will now be discussed in greater detail. As introduced above, aspects of the disclosure generally relate to financial commitment tracking. A financial institution may provide investment advice and facilitate the buying and selling of financial securities (e.g., financial assets) for customers (e.g., clients, traders, investors, and the like). A customer may offer securities as collateral to the financial institution to secure trade transactions. The use of collateral may provide credit risk reduction and improve market liquidity for the customer and the financial institution. Regulatory organizations may establish certain standards and regulations that govern transactions and activities of financial institutions. For example, regulations may dictate predefined periods of time for certain trade transactions to be performed within, as well as certain limits and exclusions for purchases of securities. In order to comply with various regulations, a financial institution may set internal policies and track and manage financial commitments with customers with respect to the internal policies.

The present disclosure teaches systems and methods for financial commitment tracking, wherein employees within a financial institution may monitor and manage transactions and commitments for a number of customer accounts. For instance, an employee of the financial institution (e.g., a financial advisor) may employ a workstation (e.g., workstation 201) to input, in a commitment tracking system, financial data regarding a financial commitment for a customer of a financial institution. The financial commitment may comprise a pledge or an obligation made by the customer offering property or assets to the financial institution as collateral for trade transactions. The employee may receive information regarding a new purchase order (e.g., a new commitment) or information regarding a decline in account value (e.g., decline in collateral value) for a previously entered financial commitment. For example, the market value of a financial asset held as collateral by the financial institution may decline, and the financial institution may take appropriate action based on the declination of collateral value.

The commitment tracking system may receive, via the workstation, the financial data regarding the financial commitment and determine an action item based on the received financial data regarding the financial commitment. For example, the determined action item may comprise one of a compliance action item, a collection action item, or a violation action item. The commitment tracking system may then assign a priority level and one or more due dates for the action item based on financial regulations. The financial regulations may be established by regulatory organizations or may be based on internal policies set by the financial institution to comply with governmental and non-governmental agency regulations. The priority level may indicate that the action item is overdue, currently due, or due at a later date, whereas the one or more due dates may correspond to at least one of a customer due date, a branch office due date, a home office, due date, or a compliance due date.

After assigning the priority level and the one or more due dates, the commitment tracking system may generate an interface displaying relevant information for the financial commitment associated with the customer. The interface may display the action item, the priority level, and the one or more due dates. The commitment tracking system may send the generated interface to one or more workstation, wherein each workstation is associated with an employee of the financial institution. Overall, the commitment tracking system may provide employees with one or more interfaces that present different financial commitments and show corresponding action items, priority levels, and due dates for each commitment. Employees may utilize the commitment tracking system to comprehensively monitor, track, update, and/or manage data associated with financial commitments for multiple accounts.

In the discussion below, various examples illustrating financial commitment tracking and management in accordance with one or more embodiments will be provided.

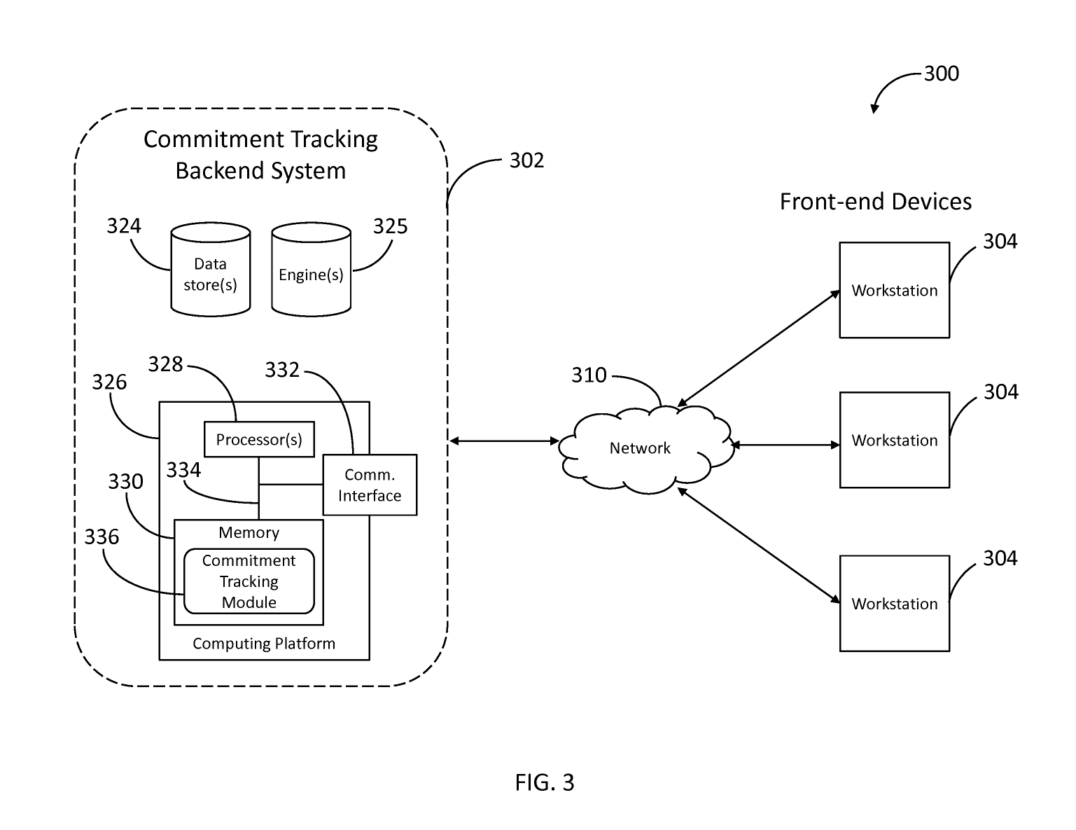

FIG. 3 depicts an illustrative computing environment for financial commitment tracking in accordance with one or more example embodiments. Referring to FIG. 3, computing environment 300 may be used for implementing example embodiments according to the present disclosure. Computing environment 300 may include a commitment tracking system 302 and a plurality of workstations 304 connected by network 310.

According to one or more aspects, computing environment 300 may be associated with a financial institution, such as a bank. Various elements may be located within the financial institution and/or may be located remotely from the financial institution. For instance, one or more workstations 304 may be located within a branch office of a financial institution. Each workstation 304 may be associated with an employee in the financial institution. Each workstation 304 may be used, for example, by a customer service representative, financial advisor, financial trader, branch manager, or another employee of the financial institution in managing financial accounts and transactions via network 310. Additionally or alternatively, one or more workstations 304 may be located at a user location (e.g., at an employee's home). In an embodiment, there may be any number of workstations 304 in computing environment 300. Workstations 304 may be the same as workstations 201 illustrated in system 200, and each workstation 304 may be a front-end device, comprising a user interface for receiving and sending data to one or more backend systems (e.g., commitment tracking system 302) in computing environment 300. Computing environment 300 may also include one or more networks, which may interconnect one or more of workstations 304 and/or commitment tracking system 302. For example, computing environment 300 may include network 310. Network 310 may include one or more sub-networks (e.g., LANs, WANs, or the like).

Commitment tracking system 302 may include a number of different backend systems or subsystems for implementing features of the present disclosure. In some arrangements, all of the subsystems included in commitment tracking system 302 may be included in and/or incorporated into a single computing device, while in other arrangements, each subsystem included in commitment tracking system 302 (and/or combinations thereof) may be included in and/or incorporated into a distinct and/or dedicated computing device.

Commitment tracking system 302 may be employed to process instructions and data received from, and transactions entered into by, an employee associated with each workstation 304. Commitment tracking system 302 may manage financial commitments or loan commitments between customers and the financial institution. In an embodiment, commitment tracking system 302 may be referred to as a loan management system or a financial commitment management system.

Additionally, commitment tracking system 302 may comprise one or more data stores 324 and one or more engines 325. Data stores 324 may comprise a number of databases that may be configured to store financial data associated with a plurality of financial commitments. In an embodiment, a financial commitment may represent an obligation made to a financial institution by a customer for a trade transaction. In some instances, a financial commitment may be made by a customer offering cash, property, assets, or securities to the financial institution as collateral for trade transactions. For example, the customer may deposit collateral into a margin account to cover the credit risk of the financial institution for a trade transaction.

One or more data stores 324 may store financial data (e.g., financial commitment details) such as obligation amounts (e.g., monetary amount of collateral), asset quantities (e.g., number of collateral assets), number of shares bought and/or sold, monetary amounts of the total shares bought and/or sold, origin or trade dates, due dates, transaction notes, and the like. Each financial commitment may correspond to a specific account (e.g., a margin account, an investment retirement account, and the like) of the customer, along with account information and details. One or more data stores 324 may also store the account information and details for each account for a plurality of customers of the financial institution. Account information and details may comprise the customer's age, gender, geographic location, employment, salary, level of investment risk, current assets, and the like. In some embodiments, a customer may have a plurality of accounts with the financial institution (e.g., a margin account, an investment retirement account, and the like). One or more data stores 324 may store account information and details corresponding to each of the customer's accounts.

One or more data stores 324 may also store instructions and policies for monitoring and managing the financial data. For example, data stores 324 may comprise instructions and internal policies based on regulations from government organizations such as the Federal Industry Regulatory Authority (FINRA) and the Securities and Exchange Commission (SEC). FINRA is responsible for governing the activities of stockbrokers and brokerage firms in the securities industry in the United States, whereas the SEC is responsible for protecting investors, ensuring fairness, and maintaining integrity in the securities industry. Additional rules and regulations may be set through the New York Stock Exchange (NYSE), the Federal Reserve, and other organizations or agencies.

Specifically, organizations, such as FINRA, SEC, and the like, may set certain regulatory standards and policies for financial institutions and organizations to follow. These regulations may dictate predefined periods of time for certain trade transactions to be performed within, as well as certain limits and prohibitions for purchases of securities. For example, FINRA rule 4210 describes the margin conditions that determine the amount of collateral customers are expected to maintain in their margin accounts. A margin may represent collateral (e.g., assets or securities) that is deposited by a customer to cover the credit risk of the financial institution. For example, the collateral may be in the form of cash or securities and may be deposited in the margin account. A customer may keep the amount posted in a margin account at a minimum margin condition to comply with various regulations, including FINRA rule 4210.

Another regulatory standard may include Regulation T, which is defined by the Federal Reserve, to govern the extension of credit and to control margin conditions for stocks bought on margin. For example, according to Regulation T, there may be a three day settlement period for settling transactions for customers of a financial institution. For example, the customer may purchase an asset (e.g., initiate a financial commitment for purchasing eligible securities) and have three days to pay for the purchase. The three day settlement period may be considered an extension of credit from the financial institution to the customer, in which a line of credit may be given to the customers to allow trade. In some embodiments, the three day settlement period may be referred to as “trade day plus 3 days” or “T+3.” In other embodiments, the customer may have an additional grace period of two days (e.g., a maximum of up to five business days) to pay for a purchase.

In order to comply with the numerous standards for the different regulatory organizations, the financial institution may set internal policies which may be stored in the one or more data stores 324 and implemented by the one or more engines 325. The one or more engines 325 may comprise policy engines that allow the financial institution to create, monitor, and enforce rules or policies for monitoring financial data for compliance with regulations. In an embodiment, the one or more engines 325 may be configured to execute rules or policies that are stored in the one or more data stores 324. In another embodiment, the one or more engines 325 may also access financial commitment data stored in the one or more data stores 324 and apply rules or policies to the financial commitment data.

In some instances, a customer may authorize a financial institution to act on behalf of the customer. For example, the customer may authorize the financial institution to invest the customer's funds, distribute funds to one or more beneficiaries, transfer funds to another account, buy and/or sell stocks, and change account settings, among numerous other actions the financial institution may perform for the customer. There may be programmed rules and policies that allow the one or more engines 325 to perform numerous actions on behalf of the customer, such as closing out financial commitments and liquidating funds for certain financial commitments according to financial standards. For example, if funds for a customer have dropped in value, thereby generating a need for additional collateral, the one or more engines 325 may automatically liquidate certain funds for the customer account. By implementing policies with the one or more engines 325, the commitment tracking system 302 may be able to ensure compliance with financial standards.

The one or more engines 325 may also rely on programmed rules to grant role-based permissions for different employees associated with workstations 304, wherein different employees may have varying levels of access to financial data and account information for various customer accounts. In an embodiment, the one or more engines 325 may comprise at least one or more of the following: a policy engine, a Structured Query Language (SQL) engine, an accounts payable (AP) engine, and the like.

Commitment tracking system 302 may also include one or more computing platforms. For example, commitment tracking system 302 may include computing platform 326. Computing platform 326 may include one or more computing devices configured to perform one or more of the functions described herein. For example, computing platform 326 may include one or more computers (e.g., laptop computers, desktop computers, servers, server blades, or the like). In an embodiment, the one or more data stores 324 and/or the one or more engines 325 may be included as components within computing platform 326 or as separate distinct components from computing platform 326.

Computing platform 326 may include one or more processor(s) 328, memory 330, communication interface 332, and data bus 334. Data bus 334 may interconnect processor(s) 328, memory 330, and/or communication interface 332. Communication interface 332 may be a network interface configured to support communication between computing platform 326 and network 310, or one or more sub-networks thereof. Memory 330 may include one or more program modules comprising instructions that when executed by processor(s) 328 cause computing platform 326 to perform one or more functions described herein. For example, memory 330 may include commitment tracking module 336, which may comprise instructions that when executed by processor(s) 328 may cause computing platform 326 to perform one or more functions described herein.

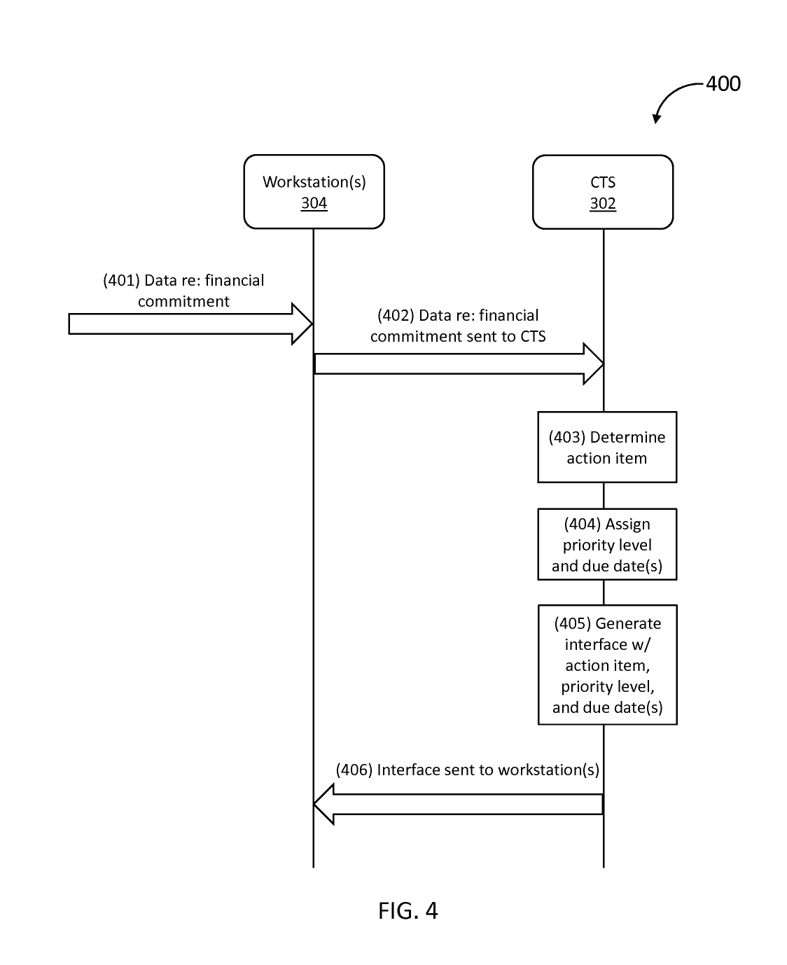

FIG. 4 depicts an illustrative sequence diagram for financial commitment tracking in accordance with one or more example embodiments. Diagram 400 shows a sequence of steps for communication between one or more workstations 304 and commitment tracking system 302. The commitment tracking system 302 may comprise the one or more data stores 324, the one or more engines 325, and computing platform 326, wherein each of the components may be employed to implement the features described herein. As illustrated in FIG. 4, in step 401, one or more workstations 304 may receive data regarding a financial commitment in a financial institution. Each workstation 304 may be associated with an employee in the financial institution. Employees may provide customers with varying financial products and services, such as financial advice and investment banking services. The data received by the employee at workstation 304 may be financial data regarding a financial commitment for a customer of the financial institution. In an embodiment, an employee may receive calls from different customers regarding financial commitments. A customer may contact an employee in the financial institution to provide certain information regarding a financial commitment. For example, the customer may request that a certain action be taken with regards to the financial commitment. In another example, the customer may wish to deposit funds into his or her account. In another embodiment, the employee may receive information or data regarding a financial commitment for a customer internally (e.g., from another employee) in the financial institution or externally from a regulatory organization.

At step 402, the employee may submit the received financial data to the commitment tracking system 302 via workstation 304. For example, the employee may input the data regarding the financial commitment through a user interface of the workstation 304, wherein the data is transmitted to the commitment tracking system 302 by the network 310. Based on the received financial data, at step 403, the commitment tracking system 302 may determine an action item for the financial commitment associated with the customer. There may be different types of action items, including compliance action items, collection action items, and violation action items. Action items may allow an employee or user associated with the commitment tracking system 302 to easily identify whether or not a customer is meeting financial regulations (e.g., identified via a compliance action item), whether or not the customer owes money to the financial institution (e.g., identified via a collection action item), or whether or not the customer is in violation of financial regulations (e.g., identified via a violation action item) for one or more financial commitments with the financial institution. These types of action items, as well as examples of each, are described in detail below. In an embodiment, the commitment tracking system 302 may analyze the received financial data from the workstation 304 in order to determine the content of the data and with what specifically the data is associated. Based on this analysis, the commitment tracking system 302 may determine and/or assign a particular action item for the financial commitment. For example, the commitment tracking system 302 may parse the received financial data for keywords and/or phrases related to an action item. Each action item may have one or more corresponding keywords and/or phrases. These keywords and/or phrases may be predefined in the commitment tracking system 302 or defined by the employee via workstation 304. Upon parsing the received financial data, the commitment tracking system 302 may identify one or more keywords and/or phrases and determine the action item corresponding to the one or more keywords and/or phrases. The commitment tracking system 302 may then assign the corresponding action item to the financial commitment.

At step 404, the commitment tracking system 302 may assign a priority level and one or more due dates for the action item for the financial commitment. The priority level and the one or more due dates may be assigned based on financial regulations. Certain financial regulations may dictate when a financial commitment is due or by when a trade transaction is to be completed. For example, as previously mentioned, there may be a three day settlement period for settling transactions for customers of a financial institution. One or more due dates may be assigned to the action item for the financial commitment based on this settlement period. For example, if the origin date (e.g., trade date) for the financial commitment is on Monday, then the customer may have a due date of Thursday (e.g., trade date plus 3 days) to complete the transaction (e.g., pay for a purchase). One or more due dates may be assigned based on the regulations, wherein one or more due dates may correspond to at least one of a customer due date, a branch office due date, a home office, due date, or a compliance due date.

In an embodiment, there may be different due dates assigned for employees and customers with financial commitments. With respect to the three day settlement period, a first due date may be assigned to the customer to take a certain action for the financial commitment. For example, the customer may make a deposit into an account or liquidate assets for the financial commitment. A second due date may be assigned to one or more employees at a branch office of the financial institution to monitor the financial commitment and enforce policies. A third due date may be assigned to one or more employees at a home office of the financial institution to make sure there are no violations and to ensure compliance by force liquidating any accounts that may be in violation. The multiple due dates may allow the customer, in addition to employees or members of different departments in the financial institution, to ensure that the financial commitment and related account activities are compliant with financial regulations.

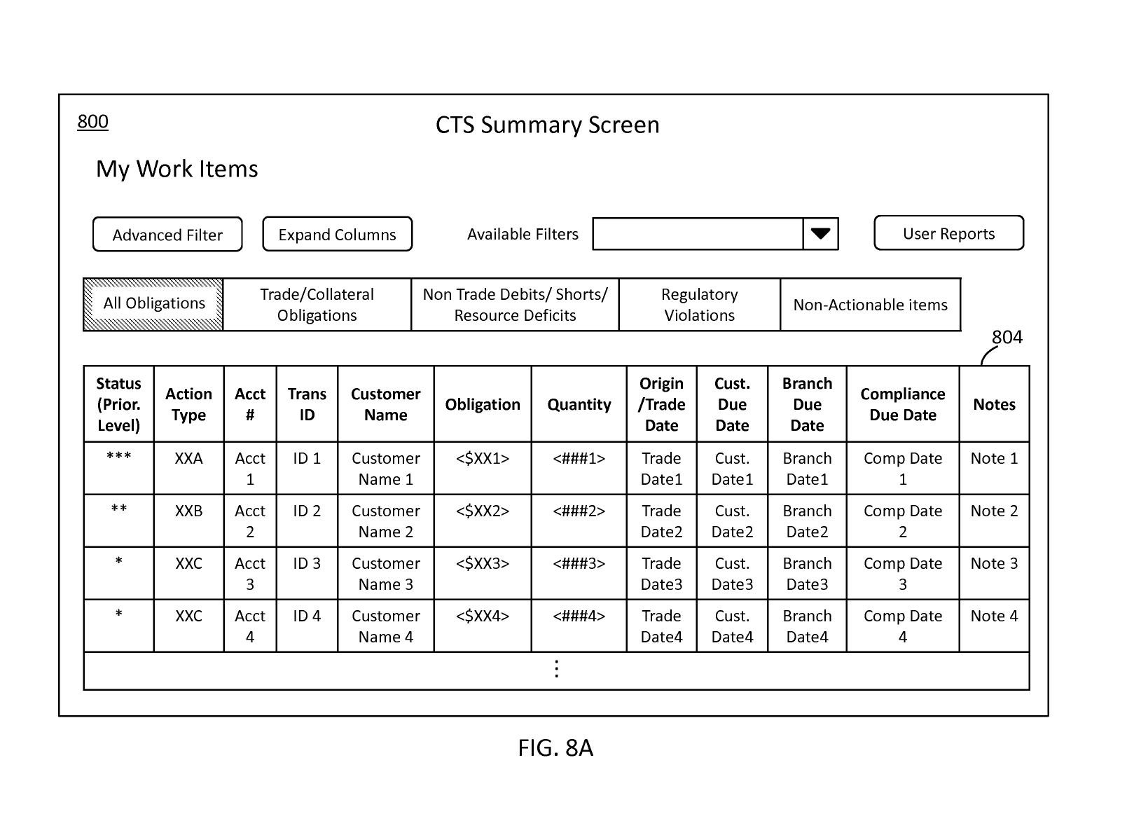

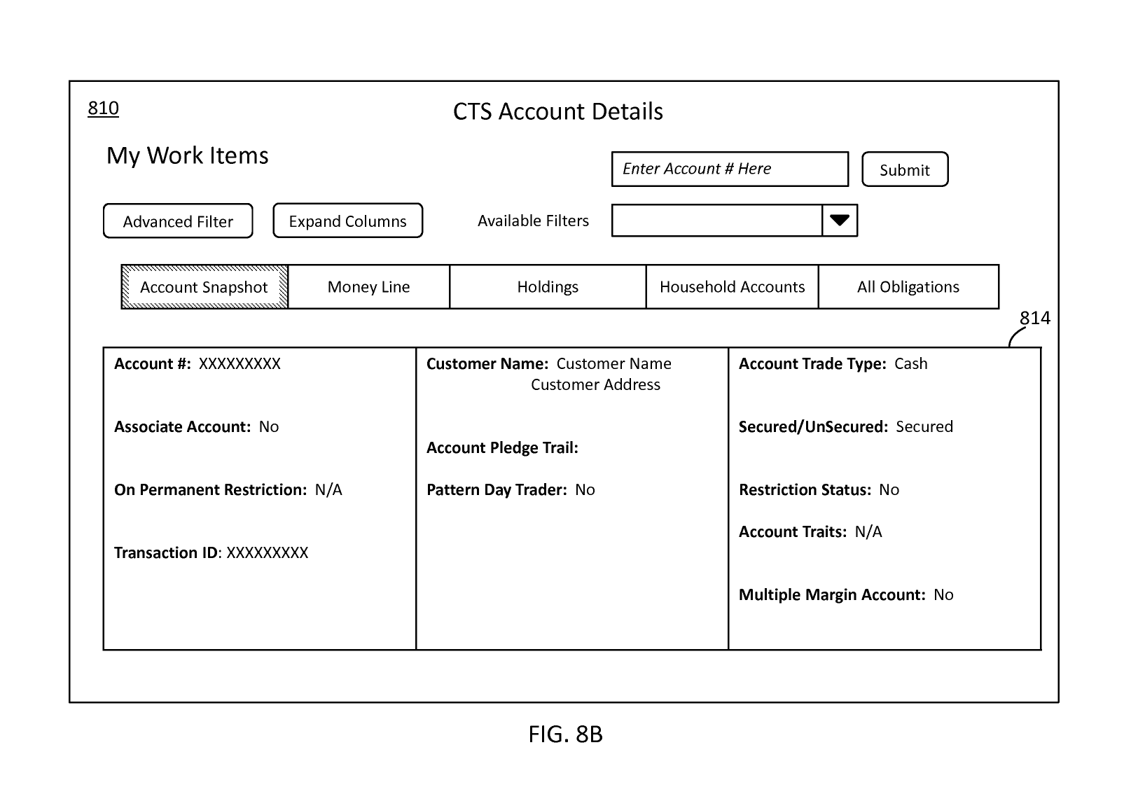

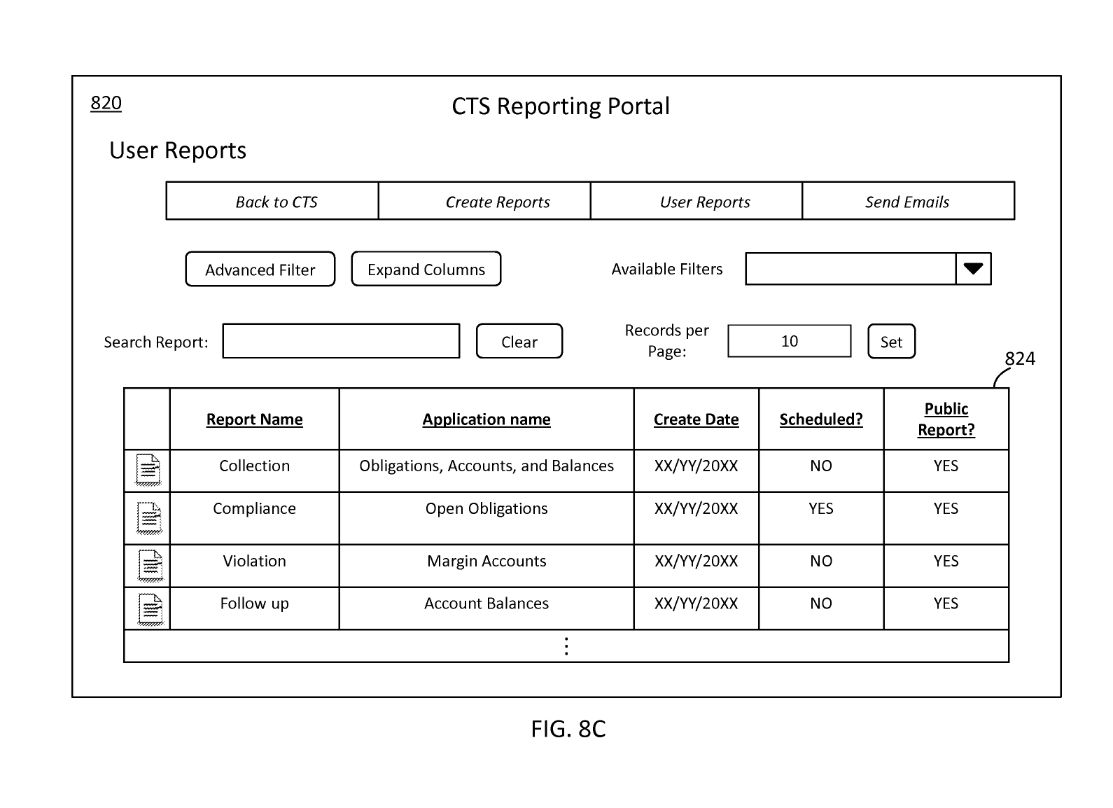

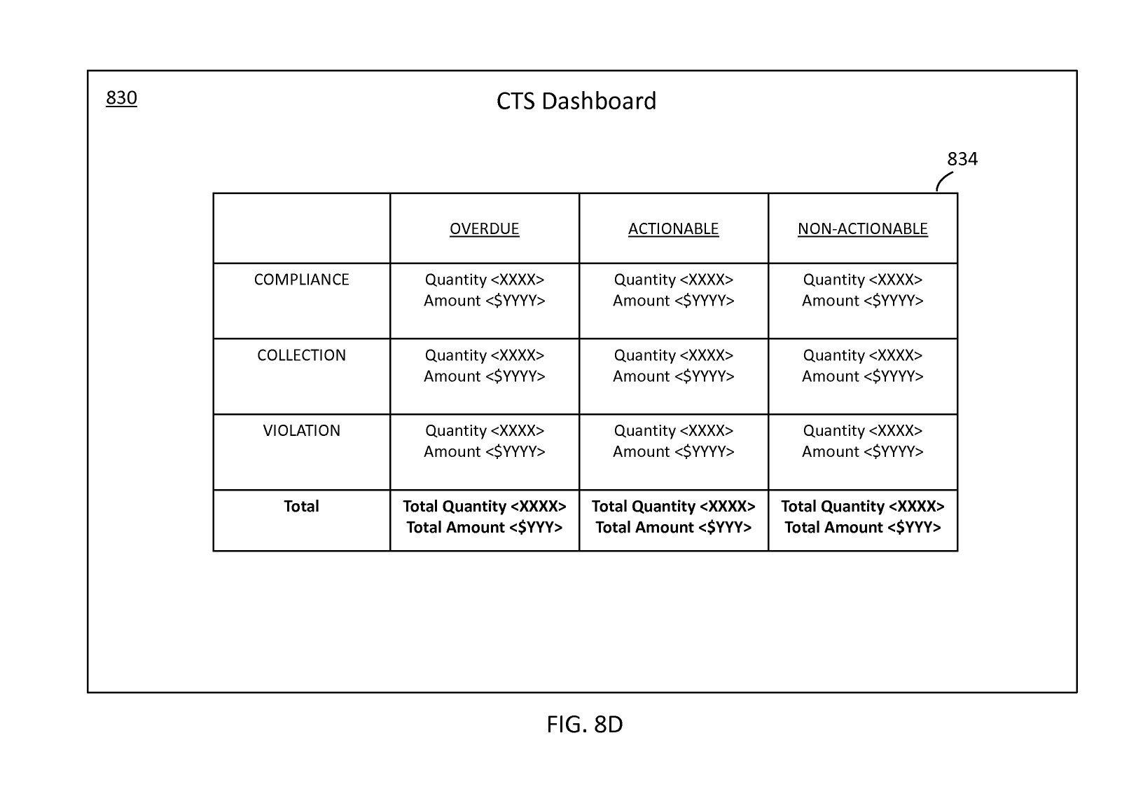

In an embodiment, the priority level may be assigned based on the severity of the action item. For example, a violation action item may have a higher priority level than a collection action item. That is, a violation action item may be deemed more detrimental to a financial commitment than a collection action item related to, for example, a resource deficit. In another embodiment, the priority level may be based on the one or more due dates. In an embodiment, there may be a first priority level indicating that the action item is overdue, a second priority level indicating that the action item is currently due, or a third priority level indicating that the action item is due at a later date. After the priority level and one or more due dates have been assigned, at step 405, the commitment tracking system 302 may generate an interface comprising the action item, the priority level, and the one or more due dates for the action item for the financial commitment. At step 406, the commitment tracking system 302 may send the interface comprising the action item, the priority level, and the one or more due dates for the action item for the financial commitment to the one or more workstations 304. Examples of the interface presented on the one or more workstations 304 are described and illustrated below with respect to FIGS. 8A-8D.

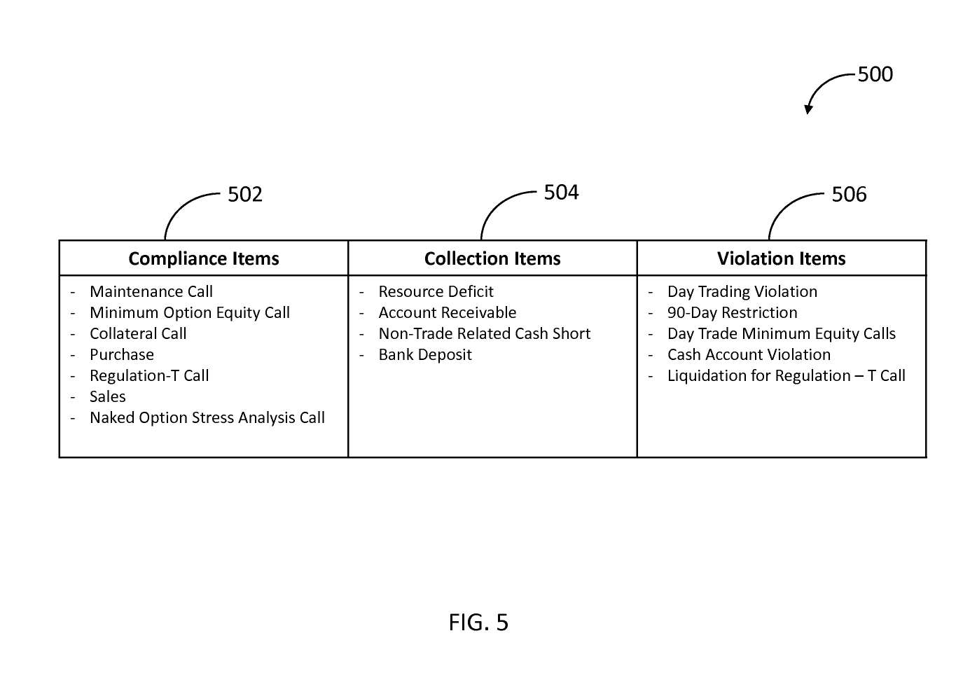

FIG. 5 depicts an illustrative table of action items for financial commitments in which various aspects of the disclosure may be implemented. Table 500 illustrates examples of action items that may be determined by the commitment tracking system 302 (e.g., at step 403), including compliance action items 502, collection action items 504, and violation action items 506. Compliance action items 502 may include action items that are assigned to ensure that certain financial commitments for customer accounts are complying with regulations. For example, commitment tracking system 302 may receive data regarding a financial commitment from an employee at a workstation 304. The commitment tracking system 302 may then determine a compliance action item based on the received data for the financial commitment. Compliance action items 502 may include action items related to maintenance calls, minimum option equity calls, collateral calls, regulation T calls, naked option stress analysis (NOSA) calls, purchases or sales.

Maintenance calls may be related to maintenance margins, wherein a maintenance margin represents the minimum amount that a customer may be obligated to maintain in a margin account according to FINRA or SEC rules (e.g., minimum margin condition). For example, a financial institution may want a customer to keep a certain amount of margin readily available in his or her account. In some instances, this maintenance margin (e.g., also known as a maintenance condition) may comprise a predetermined percentage (e.g., 25-40%) of the total market value of securities in the margin account. A customer may receive a margin call or maintenance call (e.g., a notification from the financial institution) if the amount posted to his or her margin account (e.g., the amount of securities) falls below or is close to dropping below the minimum margin condition.

Minimum option equity calls or collateral calls (e.g., notifications) may be issued by the financial institution if a customer does not maintain a minimum equity condition or a minimum collateral condition, respectively (e.g., by maintaining a certain amount of collateral or equity in the customer's account). Regulation T calls may comprise notifications by the financial institution regarding initial margin for new commitment conditions (e.g., conditions for new securities transactions and commitments). A customer may deposit margin, in cash and/or securities, in an account which is at least greater than the amount specified according to Regulation T. Additionally, a customer may have a maximum of five business days to pay for securities purchased in a cash or margin account. A Regulation T call or notification may be issued to the customer to ensure compliance with these conditions. Naked option stress analysis (NOSA) calls may be notifications issued to customers by the financial institution due to results from stress tests that assess financial commitments of customer accounts. Naked option stress analysis (NOSA) may comprise a tool that identifies risks involved in trades by focusing on and applying stress testing to the naked options in a customer account. NOSA calls may allow financial institutions to monitor customer accounts and evaluate how financial commitments may be affected during a hypothetical financial crisis (e.g., through stress testing simulations).

Compliance action items 502 may also be related to purchases and sales. There may be various financial regulations that govern purchasing and selling the same security on the same day in a margin account (e.g., day trading). For example, customers may be obligated to comply with short sale rules and identify a transaction as a “short sale” according to FINRA and SEC regulations. After receiving data associated with at least one of the aforementioned calls, notifications, purchases, or sales, the commitment tracking system 302 may assign a compliance action item 502 to the corresponding financial commitment. The compliance action item 502 may indicate that a certain action is to be taken to maintain compliance with the financial regulations.

Collection action items 504 may include action items that are assigned to collect funds for certain financial commitments for customers. In an embodiment, collection action items 504 may include action items related to a resource deficit, an account receivable, or a non-trade related cash shortage. A resource deficit may refer to when a customer has no funds in his or her account, and the financial institution extends credit to the customer. An account receivable may indicate money owed by a customer to the financial institution for services that have been delivered but not yet paid for. A non-trade related cash shortage may refer to a shortage in cash flow (e.g., not enough funds) to meet obligations in a customer's financial account. In an embodiment, the commitment tracking system 302 may receive data associated with at least one of a resource deficit, an account receivable, or a non-trade related cash shortage, and the commitment tracking system 302 may determine a collection action item 504 to collect funds for the corresponding financial commitment based on the received data.

Violation action items 506 may include action items that are assigned to notify customers and/or employees of the financial institution that certain financial commitments for customers are in violation of financial regulations. In an embodiment, violation action items 506 may include action items related to a day trading violation, a predetermined period of time restriction violation (e.g., a 90-day restriction violation), a day trade minimum equity call, a cash account violation, or a regulation T call violation.

A day trading violation may result from failure to comply with FINRA's margin rules for day trading. Day trading may refer to purchasing and selling the same security or asset within the same trading day in a margin account. If a customer engages in four or more day trades within five business days, the customer may be designated as a pattern day trader. Financial institutions may impose special margin conditions on margin accounts of pattern day traders according to comply with FINRA rules. An example of a margin condition for pattern day traders is a specific minimum equity condition. A pattern day trader may be obligated to deposit the minimum equity condition into an account prior to any day trading activities and maintain the minimum amount in the account. If the pattern day trader's account balance falls below the condition, the pattern day trader may be issued a violation action and might not be permitted to day trade until the pattern day trader restores the account to the minimum equity level.

A restriction violation may result from failure to follow trading rules, such as rules in the Federal Reserve Board's Regulation T. For example, there may be rules against free riding, which refers to buying shares or securities without having the capital to cover the trade. According to Regulation T, an investor is not permitted to buy and sell a security before paying for the security because it violates credit extension provisions of the Federal Reserve Board. Free riding may result in a restriction violation for the customer, in which the financial institution is obligated to freeze the customer's account for a predetermined period of time. In some embodiments, the restriction violation may be for any period of time, including 90 days (e.g., a 90-day restriction), during which the privilege of delaying payment beyond a trade date is withdrawn for the period of time following the date of the sale for a security. In a 90-day restriction violation, a customer may be allowed to purchase securities with his or her account, but the customer may be obligated to fully pay for any purchase on the date of the trade.

A day trade minimum equity call may be a notification issued by the financial institution if a customer does not maintain a certain amount of collateral or equity in customer account. For example, day traders may have specific minimum equity conditions, in which a day trader may be obligated to deposit a certain amount into an account prior to any day trading activities. In some embodiments, the day trader may be given a predefined grace period to deposit funds into the account to meet the minimum equity condition. After the grace period, the day trader may be issued a violation action item for failing to meet the day trade minimum equity condition.

Other violations may include cash account violations. A cash account violation may be related to a customer purchasing securities without having settled funds in an account to pay for the transaction. For example, a customer may be issued a violation if the customer sells a security that was purchased with unsettled funds (e.g., purchased with funds before the end of a three day settlement period) and then sold prior to the settlement of the first sell. This type of violation may be referred to as a good faith violation in that the customer may be abusing credit offered in good faith by the financial institution. Another cash account violation may include a short sale violation. As previously mentioned, customers may be obligated to comply with FINRA and SEC rules for transactions that are done within a shortened period of time.

A liquidation for Regulation T call violation may be issued to a customer for failing to comply with Regulation T conditions. For example, according to Regulation T, there may be a three day settlement period for settling transactions for customers of a financial institution. The financial institution may issue a liquidation for Regulation T call violation to a customer if the customer sells settled securities after the trade date of a new purchase to pay for the new purchase. These different violations and other violations may lead to trading restrictions being placed on the customer account. In an embodiment, the commitment tracking system 302 may receive data associated with at least one of the aforementioned violations, and the commitment tracking system 302 may determine a violation action item 506 to assign to the corresponding financial commitment based on the received data so that the violation may be resolved in the future.

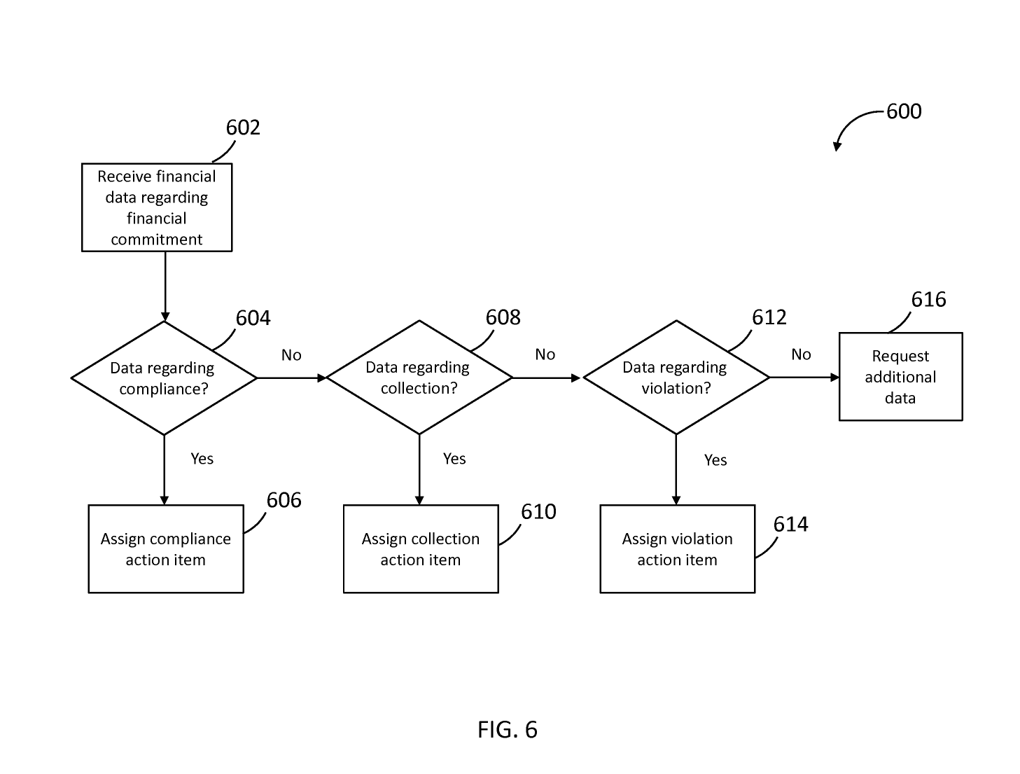

FIG. 6 depicts an example of a flow diagram for determining action items for financial commitments in which various aspects of the disclosure may be implemented. The steps illustrated in the flow diagram 600 may be performed by, for example, commitment tracking system 302. At step 602, the commitment tracking system may receive financial data regarding a financial commitment for a customer. The financial data may be received from an employee via the workstation 304. The financial data may be regarding collateral assets of a customer for a financial commitment with a financial institution. At step 604, the commitment tracking system may analyze the received financial data to determine if the data is related to compliance. For example, the commitment tracking system may parse the received financial data for keywords and/or phrases corresponding to compliance. Each action item, including a compliance action item, may have one or more corresponding keywords and/or phrases. These keywords and/or phrases may be predefined in the commitment tracking system 302 or defined by the employee via workstation 304. Upon parsing the received financial data, the commitment tracking system may identify one or more keywords and/or phrases and determine the action item corresponding to the one or more keywords and/or phrases. For example, the commitment tracking system may determine if the received financial data is associated with at least one of a maintenance call, a minimum option equity call, a collateral call, a regulation T call, a naked option stress analysis call, a purchase, or a sale (e.g., by parsing the received financial data for one or more keywords and/or phrases). If one or more keywords and/or phrases are identified, then the commitment tracking system may determine the action item corresponding to the one or more keywords and/or phrases to be a compliance action item. If the received financial data is determined to be related to compliance, the flow diagram 600 may proceed to step 606, wherein the commitment tracking system may assign a compliance action item to the financial commitment. The compliance action item may indicate that a certain action may be taken to maintain compliance with financial regulations for the financial commitment.

If the received financial data is determined not to be related to compliance, the flow diagram 600 may proceed to step 608. At step 608, the commitment tracking system may proceed to analyze the received financial data to determine if the data is related to collection. For example, the commitment tracking system may parse the received financial data for keywords and/or phrases corresponding to collection. Upon parsing the received financial data, the commitment tracking system may identify one or more keywords and/or phrases and determine the action item corresponding to the one or more keywords and/or phrases. For example, the commitment tracking system may determine if the received financial data is associated with at least one of a resource deficit, an account receivable, or a non-trade related cash shortage (e.g., by parsing the received financial data for one or more keywords and/or phrases). If one or more keywords and/or phrases are identified, then the commitment tracking system may determine the action item corresponding to the one or more keywords and/or phrases to be a collection action item. If the received financial data is determined to be related to collection, the flow diagram 600 may proceed to step 610, and the commitment tracking system may assign a collection action item to the financial commitment. The collection action item may indicate that funds are to be collected from the customer associated with the financial commitment.

If the received financial data is determined not to be related to collection, the flow diagram 600 may proceed to step 612. At step 612, the commitment tracking system may proceed to analyze the received financial data to determine if the data is related to violation. For example, the commitment tracking system may parse the received financial data for keywords and/or phrases corresponding to violation. Upon parsing the received financial data, the commitment tracking system may identify one or more keywords and/or phrases and determine the action item corresponding to the one or more keywords and/or phrases. For example, the commitment tracking system may determine if the received financial data is associated with at least one of a day trading violation, a predetermined period of time restriction violation (e.g., a 90-day restriction violation), a day trade minimum equity call, a cash account violation, or a regulation T call violation. (e.g., by parsing the received financial data for one or more keywords and/or phrases). If one or more keywords and/or phrases are identified, then the commitment tracking system may determine the action item corresponding to the one or more keywords and/or phrases to be a violation action item. If the received financial data is determined to be related to violation, the flow diagram 600 may proceed to step 614, wherein the commitment tracking system may assign a violation action item to the financial commitment. The violation action item may indicate that an action may be taken to resolve a violation of financial regulations for the financial commitment. In the case where the received financial data is determined not to be related to compliance, collection, or violation, the commitment tracking system may request for additional data at step 616. The commitment tracking system may continue to receive additional data regarding the financial commitment (e.g., at step 616) and assign action items accordingly.

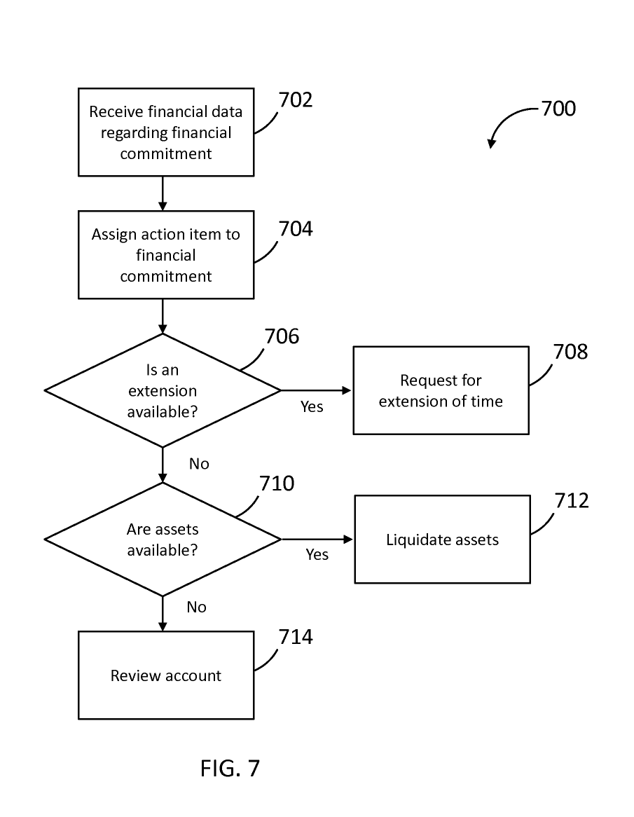

FIG. 7 depicts an example of a flow diagram for ensuring compliance for financial commitments in which various aspects of the disclosure may be implemented. Specifically, FIG. 7 illustrates various actions that may be taken to resolve an action item for a financial commitment and maintain compliance with financial regulations. The steps illustrated in the flow diagram 700 may be performed by, for example, commitment tracking system 302. At step 702, the commitment tracking system may receive data regarding a financial commitment. The data may be received from an employee via the workstation 304. In an embodiment, the data may be regarding collateral assets of a customer who is not meeting financial regulations (e.g., in violation of financial regulations). For example, the customer might not be maintaining a minimum collateral condition in his or her account according to financial regulations. At step 704, the commitment tracking system may assign an action item to the financial commitment based on the received financial data. That is, the commitment tracking system may parse the received financial data for keywords and/or phrases corresponding to a particular action item. Upon parsing the received financial data for the keywords and/or phrases, the commitment tracking system may identify the action item and assign a compliance action item, a collection action item, or a violation action item to the financial commitment. For example, if the financial data received by the commitment tracking system indicates that the customer is not maintaining the minimum collateral condition (e.g., indicated by certain keywords and/or phrases), the financial commitment associated with the customer may be assigned a compliance action item. The customer may then be issued a collateral call (e.g., notification) by the financial institution to indicate that the collateral in the customer's account is below the minimum condition.

After the action item is assigned and/or determined, the commitment tracking system may perform various steps to remedy or resolve the action item. At step 706, the commitment tracking system may determine if an extension is available. In an embodiment, the commitment tracking system may assess the assigned action item to determine if an extension of credit or extension of time is available for the financial commitment. For example, a customer might not have promptly met his or her obligations for a securities transaction. According to Regulation T, the customer may have a maximum of five business days (e.g., three day settlement period plus grace period of two days) to pay for securities purchased in a cash or margin account. If the payment is not received by the end of this time period, the financial commitment tracking system may check with financial regulations to determine if an extension is available. In another example, a customer (or an employee working on an account for the customer) may anticipate that obligations for an upcoming transaction might not be met by a certain due date or deadline. The employee may utilize the commitment tracking system to check for an extension before exceeding the due date. In some cases, regulatory organizations such as FINRA and SEC may allow extensions. If this is the case, the flow diagram may proceed to step 708, wherein the commitment tracking system may request or apply for the extension of time. In an embodiment, the commitment tracking system may automatically send a request for an extension of time directly to the relevant regulatory organization. For example, the commitment tracking system may transmit the request for the extension of time to one or more computing devices associated with the relevant regulatory organization. In another embodiment, the commitment tracking system may send an instruction to a workstation associated with the employee (e.g., workstation 304) to submit a request for an extension of time to the relevant regulatory organization. The employee may submit the request for the extension of time through an interface of the commitment tracking system 302, wherein the interface is presented on the employee's workstation 304.

If an extension is not available, the flow diagram may proceed to step 710, wherein the commitment tracking system may determine if assets for the financial commitment are available. For example, if the customer has not met his or her obligations for a securities transaction, the commitment tracking system may check if the customer has any assets in an account (e.g., margin account, financial account, investment account, and the like). In an embodiment, the commitment tracking system may check any of the customer's accounts with the financial institution for assets. In another embodiment, the customer may choose which account(s) that the financial institution may take assets from to cover financial commitments. If assets are available, the flow diagram may proceed to step 712. At step 712, the commitment tracking system may liquidate the available assets for the financial commitment. That is, the commitment tracking system may liquidate all of the assets or a portion of the assets in order to cover the financial commitment. The commitment tracking system may, additionally or alternatively, liquidate assets from one or more accounts associated with the customer to cover the financial commitment, wherein the customer may choose which account(s) that the financial institution may take assets from to cover the financial commitment. For example, if funds for a customer have dropped in value, then the commitment tracking system may automatically liquidate available money funds or bank deposits for the financial commitment associated with the customer account (e.g., account selected by the customer). In other words, the commitment tracking system may close out the financial commitment and liquidate available money funds or bank deposits in the account by converting available assets to cash. If assets are unavailable, the flow diagram may proceed to step 714, wherein the commitment tracking system may determine that the account is to undergo further review. For example, the commitment tracking system may refer the account to an employee (e.g., financial advisor or obligation specialist) for further review. Upon further review and/or a follow up, the commitment tracking system may buy the customer in by paying for the transaction (e.g., a forced sale or buy-in). For example, the commitment tracking system may deposit additional margin to secure the customer's obligation or financial commitment. In an embodiment, the commitment tracking system may keep track of loans to the customer by storing data associated with the loan to the customer account in the one or more data stores 324. The commitment tracking system may notify the customer of any cash and/or margin owed to the financial institution by sending a message or report to the customer (e.g., by a bank statement, email report).

FIGS. 8A, 8B, 8C, and 8D depict example financial commitment system interfaces in accordance with one or more example embodiments. The interfaces illustrated in FIGS. 8A-8D may be generated by commitment tracking system 302 and displayed on a user interface corresponding to each workstation 304. In some embodiments, the interfaces illustrated in FIGS. 8A-8D may be generated by each workstation 304. For example, the commitment tracking system 302 may send the information for generating the interfaces to each workstation 304. Each workstation 304 may then generate the interfaces based on the information received from the commitment tracking system 302.

Referring now to FIG. 8A, interface 800 illustrates a commitment tracking system (CTS) summary screen which displays data associated with a plurality of financial commitments with the financial institution. Employees (e.g., at workstations 304) may access data regarding a plurality of financial commitments in the commitment tracking system (CTS) summary screen in interface 800. In some embodiments, each employee may be assigned to manage a subset of financial commitments for specific customers. Each employee may be able to access data associated with his or her assigned subset of financial commitments for specific customers through the CTS interface 800. The relevant data may be displayed under “My Work Items” for each employee. Table 804 illustrates exemplary financial commitments for four customers. In an embodiment, there may be any number of financial commitments for any number of customers displayed in table 804. The headings of table 804 (e.g., elements in the first row of table 804) include a status or priority level, action item type, account number, transaction ID, customer name, obligation amount, quantity, origin or trade date, customer due date, branch due date, compliance due date, and notes for each financial commitment.

In an embodiment, the status or priority level of each financial commitment may be represented by one of different colors, symbols, numbers, and the like. For example, the color red may correspond to a first priority level indicating that an action item is overdue, the color yellow may correspond to a second priority level indicating that an action item is currently due, and the color green may correspond to a third priority level indicating that an action item is due at a later date. Any other colors may be used. As shown in interface 800, the priority levels may additionally or alternatively be indicated by asterisks or another indicator. For example, an action item that is overdue may be indicated by “***”, an action item that is currently due may be indicated by “**”, and an action item that is due at a later date may be indicated by “*”. Employees may be able to determine which action items are more urgent than others based on the status or priority level indicator.

The action type of each financial commitment may indicate the action item determined by the commitment tracking system. For example, the action item may be a compliance action item, a collection action item, or a violation action item. Each action item may represent a certain action that is to be implemented with respect to the financial commitment. Action items may be represented as abbreviations or predefined codes as shown in interface 800. Each financial commitment may also be identified by an account number, transaction identification number, and a customer name. In some instances, each financial commitment may have more than one action item, wherein multiple action items may be displayed in table 804. Also, a customer may be associated with more than one financial commitment or transaction.

Additionally, the CTS interface 800 may display an obligation amount (e.g., monetary amount of collateral or monetary amount of the total shares bought and/or sold), asset quantities (e.g., number of collateral assets or number of shares bought and/or sold), an origin date of the transaction, one or more due dates, and transaction notes corresponding to each financial commitment. The one or more due dates may correspond to at least one of a customer due date, a branch office due date, a home office, due date, or a compliance due date, wherein the commitment tracking system may assign the one or more due dates based on financial regulations. Employees may also be able to add specific notes regarding a transaction to each financial commitment, wherein the notes may facilitate with action items and future transactions.

In some instances, there may be hundreds or thousands of entries shown in table 804 of the summary screen of the CTS interface 800. Employees may access specific information by selecting predefined filters (e.g., by selecting the “available filters” button) or defining new filters (e.g., by selecting the “advanced filter” button) to apply to filter data in the system. Furthermore, employees may access more details by selecting the “expand columns” button in interface 800. In another embodiment, interface 800 may allow employees to view all of the financial commitments in the system (e.g., by selecting the “All Obligations” button) or to view specific financial commitments of interest (e.g., by selecting different options such as “Trade/Collateral Obligations”, “Non Trade Debits/Shorts/Resource Deficits”, “Regulatory Violations”, and “Non-Actionable Items”). Employees may also select a heading in table 804 (e.g., select one of the elements in the first row of table 804) to prioritize items by the heading. For example, employees may wish to organize the financial commitments in table 804 by customer due dates (e.g., from earliest to the latest dates) and may do so by selecting the “Cust. Due Date” heading (e.g., or a “Customer Due Date” heading) for prioritization of the entries. Employees may essentially be able to select any of the headings to organize financial commitments based on a user-defined prioritization.

From the CTS summary screen, an employee may be able to access a variety of information and perform various functions. For example, employees may access specific details for different accounts by selecting a financial commitment displayed in table 804. Referring now to FIG. 8B, interface 810 illustrates a CTS account details screen, which may be accessed from the summary screen by employees by selecting or clicking on a particular financial commitment displayed in table 804. Upon selection of the financial commitment, interface 810 may display details for a customer account associated with the financial commitment. Interface 810 may include table 814, which provides examples of account details that may be displayed for a specific customer account. Table 814 may include an account number, transaction identification number, customer name, customer address, and other features. The other features may include one or more restriction statuses, account traits, account trade types, and the like. For example, the restriction statuses may indicate whether or not the customer account has any trading restrictions, such as for day trading violations or free riding violations (e.g., 90 day restriction). Account details in table 814 may also indicate whether or not a customer is a pattern day trader or whether or not the customer has multiple margin accounts.

From the CTS account details screen in interface 810, employees may be able to observe information regarding other financial commitments associated with a particular customer account (e.g., by selecting the “All Obligations” tab on interface 810). For example, employees may be able to see monetary amounts and assets for the particular customer. Employees may view other customer details, by selecting specific tabs on interface 810, such as the customer's money line, holdings, and household accounts. Additionally, employees may be able to see which other employees (e.g., financial advisors) are associated with the customer account (e.g., employees who have previously worked on financial commitments for the customer account). Employees may access details regarding these other employees (e.g., office phone number, branch office location) in order to discuss concerns or details regarding the customer account. The CTS account details screen shown in interface 810 may provide employees with an account snapshot of each account in the financial institution.

Referring now to FIG. 8C, interface 820 illustrates a CTS reporting portal. The CTS reporting portal may be accessible from the CTS summary screen shown in interface 800 (e.g., by selecting a “User Reports” button in interface 800). Employees may access the CTS reporting portal interface 820 in order to generate new reports, search for previous reports, and access data regarding previous reports. For example, interface 820 may allow employees to use predefined report or email templates for generating reports or emails, wherein the predefined report or email templates may be saved in the system. Predefined report or email templates may be associated with compliance liquidation notifications, day trading violation notifications, restricted stock notifications, and the like. Employees may also create new reports or emails through the CTS reporting portal interface 820, the new reports or emails comprising other compliance, collection, or violation action items of relevance.

In an embodiment, employees may be able to use the CTS reporting portal in interface 820 to send out emails to branch employees and letters to customers. For example, employees may generate email reports to send to customers or to send internally to other employees in the financial institution. For example, employees may send out emails that include customer information and account details related to specific financial commitments, wherein the emails may be sent to branch employees, managers or customers. As another feature, employees may be able to search for previously generated reports by searching key words and utilizing filters. For example, employees may be able to search for reports by searching or filtering by subject area, department name, date, employee name (e.g., the employee who created the report), and by other relevant information. In an embodiment, subject areas for reports may comprise open obligations, closed and cancelled obligations, holdings, account information, account balances, and obligations, accounts, and balance view. Employees may also be able to access or view reports from other employees if the reports are made accessible to the public (e.g., viewable by all employees at the financial institution).

Additionally, employees may utilize the CTS reporting portal to contact or send information to regulatory organizations, such as FINRA and SEC. For example, employees may request extensions through the CTS reporting portal. Employees may submit requests for extensions of time according to Regulation T and Securities Exchange Act (SEA) Rule 15c3-3, wherein SEA rule 15C-3-3 describes regulation of sale transactions as established by SEC. For example, an action item for a financial commitment may be overdue or due soon (e.g., due within a predetermined period of time (e.g., due within a few days, weeks, or months)). An employee may request a due date extension for the action item for the financial commitment. In some embodiments, the employee may send a request for a due date extension to a regulatory organization (e.g., FINRA, SEC) by submitting a report or email through the CTS Reporting portal.

Referring now to FIG. 8D, interface 830 illustrates a CTS dashboard screen. The dashboard screen may comprise a table 834 which illustrates the total number of financial commitments for each action item type, as well as total monetary amounts for financial commitments of specific action item types. For example, table 834 shows a quantity and an amount for each total number of financial commitments with compliance action items, collection action items, and violation action items. In an embodiment, table 834 may summarize the quantity and the amount for each total number of financial commitments for a particular customer, for a subset of financial commitments for specific customers assigned to an employee, and/or for all of the financial commitments for all of the customers of the financial institution. Additionally, table 834, shows total numbers for financial commitments organized by different action item types and priority levels. In an embodiment, the aforementioned first, second, and third priority levels may be characterized as “Overdue”, “Actionable”, and “Non-Actionable.” The CTS dashboard shown in interface 830 may provide a consolidated view of financial commitments. The dashboard may also be useful for work queue management for employees. Branch managers and other employees may make assessments and plan ahead for future financial commitments based on the numbers provided in the CTS dashboard.

Furthermore, the commitment tracking system as disclosed herein may be expanded to allow for additional enterprise level commitments to be added for complete client views. For example, the commitment tracking system may manage credit cards, bank loans, other open commitments or calls for equity, and the like for clients. The commitment tracking system may interface with other enterprises and may store collateral calls for specialized accounts offered by the financial institution. In an embodiment, a line of credit for a specialized account may be based on the value of the underlying assets.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
receiving, via a communication interface and from one or more computing devices, financial data regarding a financial commitment for a customer of a financial institution;
determining, by at least one processor, an action item for the financial commitment, based on the received financial data regarding the financial commitment;
assigning, by the at least one processor, a priority level and one or more due dates for the action item for the financial commitment, wherein the assignment is based on financial regulations;
generating, by the at least one processor, an interface comprising the action item, the priority level, and the one or more due dates for the action item for the financial commitment; and
sending, via the communication interface and to the one or more computing devices, the interface comprising the action item, the priority level, and the one or more due dates for the action item for the financial commitment.

2. The method of claim 1, wherein the financial data is associated with at least one of a maintenance call, a minimum option equity call, a collateral call, a naked option stress analysis call, a purchase, a sale, or a regulation T call, and wherein the action item for the financial commitment comprises a compliance action item.

3. The method of claim 1, wherein the financial data is associated with at least one of a resource deficit, an account receivable, or a non-trade related cash shortage, and wherein the action item for the financial commitment comprises a collection action item.

4. The method of claim 1, wherein the financial data is associated with at least one of a day trading violation, a predetermined period of time restriction, a day trade minimum equity call, a cash account violation, or a regulation T call violation, and wherein the action item for the financial commitment comprises a violation action item.

5. The method of claim 1, wherein the one or more due dates comprise at least one of a customer due date, a branch office due date, a home office due date, or a compliance due date.

6. The method of claim 1, comprising responsive to assigning the priority level and the one or more due dates for the action item for the financial commitment:
determining, by the at least one processor, whether an extension is available according to the financial regulations; and
in response to determining that the extension is available according to the financial regulations, sending, via the communication interface and to the one or more computing devices, an instruction to request the extension from a regulatory organization.

7. The method of claim 1, comprising responsive to assigning the priority level and the one or more due dates for the action item for the financial commitment:
determining, by the at least one processor, whether collateral assets of the customer for the financial commitment are available; and
in response to determining that the collateral assets for the financial commitment are available, sending, via the communication interface and to the one or more computing devices, an instruction to liquidate the collateral assets of the customer for the financial commitment.

8. The method of claim 1, wherein the priority level comprises at least one of a first priority indicating that the action item is overdue, a second priority level indicating that the action item is currently due, or a third priority level indicating that the action item is due at a later date.

9. The method of claim 1, wherein the determination of the action item for the financial commitment is based on the financial regulations established by the Federal Reserve, Financial Industry Regulatory Authority (FINRA), and the Securities and Exchange Commission (SEC).

10. An apparatus, comprising:
at least one processor;
a communication interface; and
a memory storing instructions that when executed by the at least one processor cause the apparatus to:
receive, via the communication interface and from one or more computing devices, financial data regarding a financial commitment for a customer of a financial institution;
determine, by the at least one processor, an action item for the financial commitment, based on the received financial data regarding the financial commitment;
assign, by the at least one processor, a priority level and one or more due dates for the action item for the financial commitment, wherein the assignment is based on financial regulations;
generate, by the at least one processor, an interface comprising the action item, the priority level, and the one or more due dates for the action item for the financial commitment; and
send, via the communication interface and to the one or more computing devices, the interface comprising the action item, the priority level, and the one or more due dates for the action item for the financial commitment.

11. The apparatus of claim 10, wherein the financial data is associated with at least one of a maintenance call, a minimum option equity call, a collateral call, a naked option stress analysis call, a purchase, a sale, or a regulation T call, and wherein the action item for the financial commitment comprises a compliance action item.

12. The apparatus of claim 10, wherein the financial data is associated with at least one of an resource deficit, an account receivable, or a non-trade related cash shortage, and wherein the action item for the financial commitment comprises a collection action item.

13. The apparatus of claim 10, wherein the financial data is associated with at least one of a day trading violation, a predetermined period of time restriction, a day trade minimum equity call, a cash account violation, or a regulation T call violation, and wherein the action item for the financial commitment comprises a violation action item.

14. The apparatus of claim 10, wherein the memory stores additional computer-executable instructions that, when executed by the at least one processor, cause the apparatus to:
determine, by the at least one processor, the action item for the financial commitment to be a compliance action item, based on the received financial data regarding the financial commitment; and
send, via the communication interface and to the one or more computing devices, an instruction to liquidate collateral assets of the customer for the financial commitment with the financial institution.

15. The apparatus of claim 10, wherein the memory stores additional computer-executable instructions that, when executed by the at least one processor, cause the apparatus to:
determine, by the at least one processor, the action item for the financial commitment to be a compliance action item, based on the received financial data regarding the financial commitment; and
send, via the communication interface and to the one or more computing devices, an instruction to request an extension from a regulatory organization.

16. The apparatus of claim 10, wherein the priority level comprises at least one of a first priority indicating that the action item is overdue, a second priority level indicating that the action item is currently due, or a third priority level indicating that the action item is due at a later date.

17. The apparatus of claim 10, wherein the determination of the action item for the financial commitment is based on the financial regulations established by the Federal Reserve, Financial Industry Regulatory Authority (FINRA), and the Securities and Exchange Commission (SEC).

18. A non-transitory computer-readable medium having instructions stored thereon that, when executed, cause a computing device to:
receive financial data regarding a financial commitment for a customer of a financial institution;
determine an action item for the financial commitment, based on the received financial data regarding the financial commitment;
assign a priority level and one or more due dates for the action item for the financial commitment, wherein the assignment is based on financial regulations;
generate an interface comprising the action item, the priority level, and the one or more due dates for the action item for the financial commitment; and
send the interface comprising the action item, the priority level, and the one or more due dates for the action item for the financial commitment.

19. The non-transitory computer-readable medium of claim 18 having additional computer-readable instructions stored thereon that, when executed, cause the computing device to:
determine whether an extension is available according to the financial regulations; and
in response to determining that the extension is available according to the financial regulations, send an instruction to request the extension from a regulatory organization.

20. The non-transitory computer-readable medium of claim 18 having additional computer-readable instructions stored thereon that, when executed, cause the computing device to:
determine whether collateral assets of the customer for the financial commitment are available; and
in response to determining that the collateral assets for the financial commitment are available, send an instruction to liquidate the collateral assets of the customer for the financial commitment.
